(19) United States
(12) Patent Application Publication
(10) Pub. No.: US 2019/0158190 A1
(43) Pub. Date: May 23, 2019

(54) OPTICAL RECEIVER MODULE AND OPERATION METHOD THEREOF

(71) Applicant: Electronics and Telecommunications Research Institute, Daejeon (KR)

(72) Inventors: Joon Young HUH, Daejeon (KR); Sae Kyoung KANG, Daejeon (KR)

(73) Assignee: Electronics and Telecommunications Research Institute, Daejeon (KR)

(21) Appl. No.: 16/194,618

(22) Filed: Nov. 19, 2018

(30) Foreign Application Priority Data
Nov. 23, 2017 (KR) 10-2017-0157146

(51) Int. Cl. H04B 10/69; H04J 14/02

(52) U.S. Cl. CPC H04B 10/69; H04J 14/02

(57) ABSTRACT

Disclosed herein are an optical receiver module and an operation method thereof. The optical receiver module includes an input part configured to receive a multiplexed optical signal of a plurality of wavelengths, an optical power/wavelength splitter configured to split the multiplexed optical signal into a plurality of channels, a wavelength filter configured to split the split multiplexed optical signal according to the plurality of wavelengths, and an output part configured to convert optical signals split according to the plurality of wavelengths into voltage signals and output the converted voltage signals. Therefore, the optical receiver module has wide bandwidth performance and low adjacent channel crosstalk performance with respect to the multiplexed optical signal.

### CLAIM FOR PRIORITY

This application claims priority to Korean Patent Application No. 10-2017-0157146 filed on Nov. 23, 2017 in the Korean Intellectual Property Office (KIPO), the entire contents of which are hereby incorporated by reference.

### BACKGROUND

### 1. Technical Field

Example embodiments of the present invention relate to an optical receiver module and an operation method thereof, and more specifically, to an optical receiver module for demultiplexing an optical signal and an operation method thereof.

### 2. Related Art

Owing to the recent rapid increase in traffic, various efforts are being made to increase transmission capacity of an optical transceiver. Wavelength division multiplexing (WDM) is one method for increasing transmission capacity of an optical transceiver. The WDM is a method for transmitting optical signals of a plurality of wavelengths by multiplexing the optical signals on one optical fiber. The WDM was initially used for a medium and long distance optical transmission network. The WDM is currently being actively applied to a short-distance optical transmission network such as Ethernet.

In 2010, standardization for 100G Ethernet was completed. Particularly, an optical transceiver developed for 100GBASE-LR4 among standardizations is a typical short-distance optical transceiver to which WDM is applied. The optical transceiver developed for the 100GBASE-LR4 can multiplex transmit four 25 Gbps optical signals of different wavelengths through a single mode fiber. In 2011, a 100G C form-factor pluggable (CFP) optical transceiver was commercialized. Thereafter, efforts have been made to reduce a floor area and power consumption of an optical transceiver. A 100G CFP2 optical transceiver was commercially available in 2013, and a 100G CFP4 optical transceiver was commercially available in 2015. Recently, research on 400G Ethernet has been actively conducted with the aim of standardization in the second half of 2017.

Conventional 100G Ethernet can use four wavelengths. On the other hand, 400G Ethernet for transmission of 2 km and 10 km distance can use 8 wavelengths. Each of the eight wavelengths can use a 50G signal. More efficient optical multiplexing/demultiplexing methods are needed to multiplex and demultiplex signals of eight wavelengths.

### SUMMARY

Accordingly, example embodiments of the present invention are provided to substantially obviate one or more problems due to limitations and disadvantages of the related art.

Example embodiments of the present invention provide an optical receiver module and an operation method thereof for demultiplexing a wavelength division multiplexing (WDM) signal using an optical power/wavelength splitter and a wavelength filter.

In some example embodiments, an optical receiver module includes an input part configured to receive a multiplexed optical signal of a plurality of wavelengths, an optical power/wavelength splitter configured to split the multiplexed optical signal into a plurality of channels, a wavelength filter configured to split the split multiplexed optical signal according to the plurality of wavelengths, and an output part configured to convert optical signals split according to the plurality of wavelengths into voltage signals and output the converted voltage signals.

The optical power/wavelength splitter may include an input port and a plurality of output ports and may receive the multiplexed optical signal through the input port.

The optical power/wavelength splitter may output the split multiplexed optical signal to the wavelength filter through each of the plurality of output ports.

The wavelength filter may include a plurality of wavelength filters. Each of the plurality of wavelength filters may receive the multiplexed optical signal output from the optical power/wavelength splitter.

Each of the plurality of wavelength filters may split at least one optical signal of a predetermined wavelength.

The wavelength filter includes first, second, third, and fourth wavelength filters. The first wavelength filter may split a first optical signal of a first wavelength from the multiplexed optical signal. The second wavelength filter may split a second optical signal of a second wavelength from the multiplexed optical signal. The third wavelength filter may split a third optical signal of a third wavelength from the multiplexed optical signal. The fourth wavelength filter may split a fourth optical signal of a fourth wavelength from the multiplexed optical signal.

The wavelength filter may include a first wavelength filter and a second wavelength filter. The first wavelength filter may split a first optical signal of a first wavelength of the multiplexed optical signal, a second optical signal of a second wavelength therefrom, a third optical signal of a third wavelength therefrom, and a fourth optical signal of a fourth wavelength therefrom. The second wavelength filter may split a fifth optical signal of a fifth wavelength therefrom, a sixth optical signal of a sixth wavelength therefrom, a seventh optical signal of a seventh wavelength thereof, and an eighth optical of an eighth wavelength therefrom.

The optical power/wavelength splitter may include a multimode interference (MMI) coupler or a planar waveguide circuit (PWC).

The wavelength filter may include at least one thin film filter (TFF).

The optical receiver module may further include an optical demultiplexer configured to demultiplex the multiplexed optical signal. The optical demultiplexer may include the optical power/wavelength splitter and the wavelength filter.

The optical power/wavelength splitter may be disposed at a first stage of the optical demultiplexer. The wavelength filter may be disposed at a second stage of the optical demultiplexer.

The output part may include an optical detector and an amplifier. The optical detector may detect the optical signals split according to the plurality of wavelengths. The amplifier converts the detected optical signals into current signals and outputs the converted current signals. The amplifier may convert the converted current signals into voltage signals and output the voltage signals.

The optical detector may include a plurality of photodiodes.

### BRIEF DESCRIPTION OF DRAWINGS

Example embodiments of the present invention will become more apparent by describing example embodiments of the present invention in detail with reference to the accompanying drawings, in which:

FIG. 1 is a block diagram illustrating an optical transceiver;

FIG. 2 is a conceptual diagram illustrating an optical receiver module;

FIG. 3 is a conceptual diagram illustrating an optical demultiplexer;

FIG. 4 is a conceptual diagram illustrating an optical demultiplexer using a planar lightwave circuit (PLC);

FIG. 5 is a conceptual diagram illustrating an optical demultiplexer using a thin film filter;

FIG. 6 is a representative structural diagram illustrating an optical demultiplexer embedded in an optical receiver module according to an embodiment of the present invention;

FIG. 7 is a diagram illustrating a 4-channel optical demultiplexer implemented with a 4-channel optical power/wavelength splitter and four wavelength filters according to an embodiment of the present invention;

FIG. 8 is a diagram illustrating an 8-channel optical demultiplexer implemented with a 2-channel optical power/wavelength splitter and two wavelength filters according to an embodiment of the present invention;

FIG. 9 is a representative block diagram illustrating an optical receiver module according to an embodiment of the present invention; and

FIG. 10 is a flowchart illustrating an operation method of the optical receiver module according to the embodiment of the present invention.

### DETAILED DESCRIPTION

Example embodiments of the present invention are disclosed herein. However, specific structural and functional details disclosed herein are merely representative for purposes of describing the example embodiments of the present invention. However, the example embodiments of the present invention may be embodied in many alternate forms and should not be construed as limited to the example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in detail with reference to the accompanying drawings. In order to facilitate a thorough understanding of the present invention, the same reference numerals are used for the same constituent elements in the drawings and an overlapping description for the same components will be omitted.

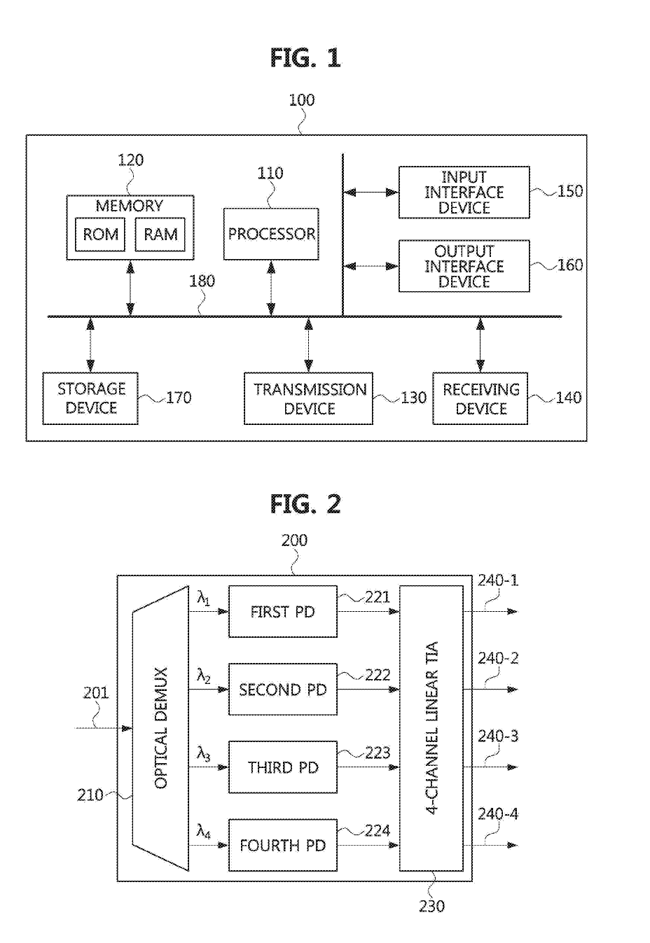

FIG. 1 is a block diagram illustrating an optical transceiver.

Referring to FIG. 1, an optical transceiver 100 may include at least one processor 110, a memory 120, a transmission device 130 connected to a network and transmit an optical signal, and a reception device 140 for receiving an optical signal. Further, the optical transceiver 100 may further include an input interface device 150, an output interface device 160, a storage device 170, and the like. Each component included in the optical transceiver 100 may be connected through a bus 180 to communicate with each other.

The processor 110 may execute a program command stored in at least one of the memory 120 and the storage device 170. The processor 110 may mean a central processing unit (CPU), a graphics processing unit (GPU), or a dedicated processor in which methods according to embodiments of the present invention are performed. Each of the memory 120 and the storage device 170 may be configured with at least one of a volatile storage medium and a nonvolatile storage medium. For example, the memory 120 may be configured with at least one of a read only memory (ROM) and a random access memory (RAM).

The transmission device 130 may be an optical transmission module. For example, the transmission device 130 may be a transmitter optical sub-assembly (TOSA) (not shown). Further, the receiving device 140 may be an optical receiver module. For example, the receiving device 140 may be a receiver optical sub-assembly (ROSA) (not shown). Further, the transmission device 130 and the receiving device 140 may be a single transceiver module. For example, the transmission device 130 and the receiving device 140 may be a single bidirectional optical sub-assembly (BOSA) (not shown).

FIG. 2 is a conceptual diagram illustrating an optical receiver module.

Referring to FIG. 2, an optical receiver module 200 may operate in the same or similar way as the receiving device 140 of FIG. 1. That is, the optical receiver module 200 may be a ROSA. For example, the optical receiver module 200 may include an optical demultiplexer (DEMUX) 210, a plurality of photodiodes (PDs) 221 to 224, a 4-channel linear transimpedance amplifier (TIA) 230. The optical receiver module 200 may be assembled in the form of a single coaxial package.

The optical DEMUX 210 may include an input port and a plurality of output ports. The optical DEMUX 210 may acquire a wavelength division multiplexing (WDM) signal 201 through the input port. The optical DEMUX 210 may demultiplex the WDM signal 201. For example, the optical DEMUX 210 may split the WDM signal 201 according to wavelengths λ₁ to λ₄. The optical DEMUX 210 may output the split signals according to the wavelengths λ₁ to λ₄ through the plurality of output ports.

The plurality of PDs 221 to 224 may detect the split optical signals output from the optical DEMUX 210. For example, each of the plurality of PDs 221 to 224 may be an optical detector made of a PIN-PD or an avalanche PD (APD).

The first PD 221 may detect a signal of the first wavelength λ₁. The first PD 221 may output a first current signal on the basis of the detected signal of the first wavelength λ₁. The second PD 222 may detect a signal of the second wavelength λ₂. The second PD 222 may output a second current signal on the basis of the detected signal of the second wavelength λ₂. The third PD 223 may detect a signal of the third wavelength λ₃. The third PD 223 may output a third current signal on the basis of the detected signal of the third wavelength λ₃. The fourth PD 224 may detect a signal of the fourth wavelength λ₄. The fourth PD 224 may output a fourth current signal on the basis of the detected signal of the fourth wavelength λ₄.

The 4-channel linear TIA 230 may convert the first to fourth current signals output from the first to fourth PDs 221 to 224 into voltage signals. For example, the 4-channel linear TIA 230 may convert the first current signal to output a first voltage signal 240-1. The 4-channel linear TIA 230 may convert the second current signal to output a second voltage signal 240-2. The 4-channel linear TIA 230 may convert the third current signal to output a third voltage signal 240-3. The 4-channel linear TIA 230 may convert the fourth current signal to output a fourth voltage signal 240-4.

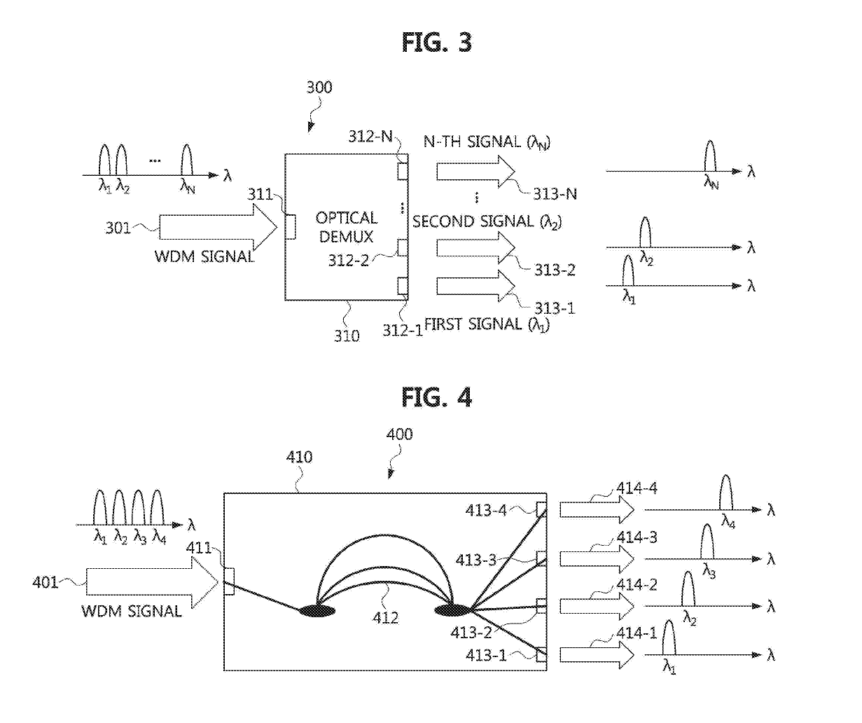

FIG. 3 is a conceptual diagram illustrating an optical DEMUX.

Referring to FIG. 3, an optical receiver module 300 may include an optical DEMUX 310. The optical DEMUX 310 may split a received WDM signal 301 to output split optical signals for each wavelength. For example, the optical DEMUX 310 may split the received WDM signal 301 according to the wavelengths using a thin film filter.

The optical DEMUX 310 may include an input port 311 and first to N-th output ports 312-1 to 312-N. The optical DEMUX 310 may receive the WDM signal 301, in which a plurality of wavelengths λ₁ to λ_{N} are multiplexed, through the input port 311. The optical DEMUX 310 may split the WDM signal 301 according to the plurality of wavelengths λ₁ to λ_{N} using a thin film filter.

The optical DEMUX 310 may output split signals 313-1 to 313-N according to the plurality of wavelengths λ₁ to λ_{N} through the first to N-th output ports 312-1 to 312-N. For example, the optical DEMUX 310 may output the first signal 313-1 through the first output port 312-1. The first signal 313-1 may be a signal of the first wavelength λ₁. The optical DEMUX 310 may output the second signal 313-2 through the second output port 312-2. The second signal 313-2 may be a signal of the second wavelength λ₂. The optical DEMUX 310 may output the N-th signal 313-N through the N-th output port 312-N. The N-th signal 313-N may be a signal of the N-th wavelength λ_{N}.

For convenience of description, FIG. 3 illustrates the optical receiver module 300 including a single optical DEMUX 310. However, the optical receiver module 300 may include a plurality of demultiplexers. Further, the optical DEMUX 310 may have a plurality of input ports.

FIG. 4 is a conceptual diagram illustrating an optical demultiplexer using a planar lightwave circuit (PLC).

Referring to FIG. 4, an optical receiver module 400 may include an optical DEMUX 410. The optical DEMUX 410 may demultiplex a WDM signal 401. For example, the optical DEMUX 410 may demultiplex the WDM signal 401 through the PLC. That is, the optical DEMUX 410 may split the WDM signal 401 according to wavelengths and output split signals. For example, the optical DEMUX 410 may split the WDM signals 401 according to the wavelengths using an arrayed waveguide grating (AWG) which is one type of the PLC.

The optical DEMUX 410 may include an input port 411 and first to fourth output ports 413-1 to 413-4. The optical DEMUX 410 may receive the WDM signal 401, in which a plurality of wavelengths λ₁ to λ₄ are multiplexed, through the input port 411. The optical DEMUX 410 may split the WDM signal 401 according to the plurality of wavelengths λ₁ to λ₄ through an AWG 412.

The optical DEMUX 410 may output split signals 414-1 to 414-4 according to the plurality of wavelengths λ₁ to λ₄ through the first to fourth output ports 413-1 to 413-4. For example, the optical DEMUX 410 may output the first signal 414-1 through the first output port 412-1. The first signal 414-1 may be a signal of the first wavelength λ₁. The optical DEMUX 410 may output the second signal 414-2 through the second output port 413-2. The second signal 414-2 may be a signal of the second wavelength λ₂. The optical DEMUX 410 may output the third signal 414-3 through the third output port 413-3. The third signal 414-1 may be a signal of the third wavelength λ₃. The optical DEMUX 410 may output the fourth signal 414-4 through the fourth output port 413-4. The fourth signal 414-4 may be a signal of the fourth wavelength λ₄.

The optical DEMUX 410 using the AWG 412 may be designed and manufactured to have constant performance regardless of the number of input and output channels. Further, the optical DEMUX 410 using AWG 412 may be excellent in mass productivity to have excellent in price competitiveness.

However, the optical DEMUX 410 using the AWG 412 may have a relatively large optical insertion loss and a low optical alignment margin. Thus, the optical DEMUX 410 using the AWG 412 may not be easily integrated into the optical receiver module 400.

The optical DEMUX 410 using the AWG 412 may be used in a large-scale optical transceiver requiring a large number of input and output channels and capable of controlling a temperature, or in a low-cost optical transceiver capable of ignoring temperature dependence.

For convenience of description, FIG. 4 illustrates the optical receiver module 400 including a single optical DEMUX 410. However, the optical receiver module 400 may include a plurality of demultiplexers. Further, for convenience of description, FIG. 4 illustrates the optical DEMUX 410 including a single input channel and four output channels. However, the optical DEMUX 410 may have a plurality of input channels. Further, the optical DEMUX 410 may have less than four output channels or more than four output channels. In other words, the optical DEMUX 410 may have a plurality of input ports. Further, the optical DEMUX 410 may have less than four output ports or more than four output ports.

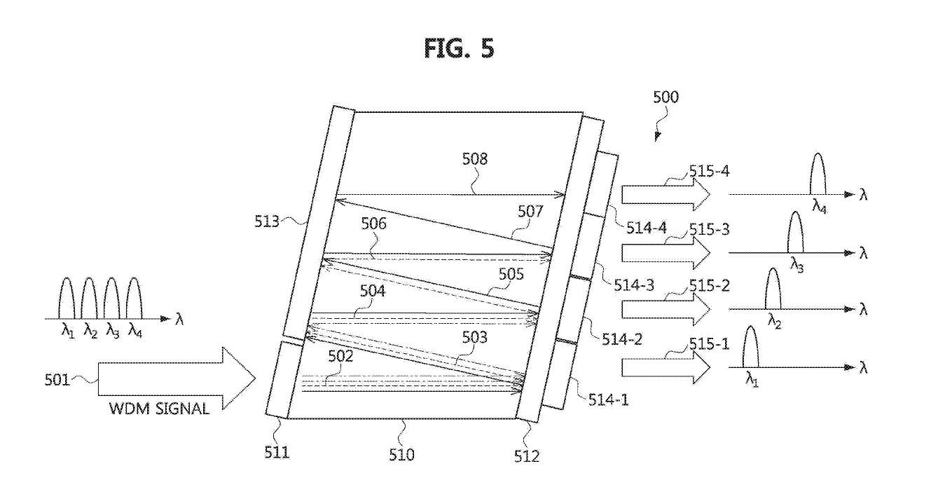

FIG. 5 is a conceptual diagram illustrating an optical demultiplexer using a thin film filter.

Referring to FIG. 5, an optical receiver module 500 may include an optical DEMUX 510. The optical DEMUX 510 may demultiplex a WDM signal 501. For example, the optical DEMUX 510 may be a zigzag type optical DEMUX using a thin film filter. The thin film filter may allow only an optical signal having a specific wavelength among optical signals of a plurality of wavelengths to pass through and reflect the remaining optical signals of other wavelengths.

The optical DEMUX 510 may demultiplex a WDM signal 501 using a plurality of thin film filters. The optical DEMUX 510 includes a first anti-reflection (AR) coating portion 511, a second AR coating portion 512, a high-reflection (HR) coating portion 513, and first to fourth thin film filters 514-1 to 514-4.

The optical DEMUX 510 may receive the WDM signal 501, in which first to fourth wavelengths λ₁ to λ₄ are multiplexed, through the first AR coating portion 511. First reflected signals 502 passing through the first AR coating portion 511 may travel in a direction toward the second AR coating portion 512. In other words, the first reflected signals 502 may travel in a direction toward the first thin film filter 514-1. At this point, a first signal 515-1 of the first wavelength λ₁ included in the first reflected signals 502 may pass through the first thin film filter 514-1. That is, the optical DEMUX 510 may output the first signal 515-1 of the first wavelength λ₁ passing through the first thin film filter 514-1.

Second reflected signals 503 not to pass through the first thin film filter 514-1 may be reflected from the first thin film filter 514-1 and may travel in the direction toward the HR coating portion 513. The second reflected signals 503 may be signals of the second to fourth wavelengths λ₂ to λ₄ except for the first wavelength λ₁. The second reflected signals 503 may be reflected from the HR coating portion 513.

Third reflected signals 504 reflected from the HR coating portion 513 may travel in the direction toward the second AR coating portion 512. In other words, the third reflected signals 504 may travel in a direction toward the second thin film filter 514-2. At this point, a second signal 515-2 of the second wavelength λ₂ included in the third reflected signals 504 may pass through the second thin film filter 514-2. That is, the optical DEMUX 510 may output the second signal 515-2 of the second wavelength λ₂ passing through the second thin film filter 514-2.

Fourth reflected signals 505 not to pass through the second thin film filter 514-2 may be reflected from the second thin film filter 514-2 and may travel in the direction toward the HR coating portion 513. The fourth reflected signals 505 may be signals of the third to fourth wavelengths λ₃ to λ₄ except for the second wavelength λ₂. The fourth reflected signals 505 may be reflected from the HR coating portion 513.

Fifth reflected signals 506 reflected from the HR coating portion 513 may travel in the direction toward the second AR coating portion 512. In other words, the fifth reflected signals 506 may travel in a direction toward the third thin film filter 514-3. At this point, a third signal 515-3 of the third wavelength λ₃ included in the fifth reflected signals 506 may pass through the third thin film filter 514-3. That is, the optical DEMUX 510 may output the third signal 515-3 of the third wavelength λ₃ passing through the third thin film filter 514-3.

A sixth reflected signal 507 not to pass through the third thin film filter 514-3 may be reflected from the third thin film filter 514-3 and may travel in the direction toward the HR coating portion 513. The sixth reflected signals 507 may be a signal of the fourth wavelengths λ₄ except for the third wavelength λ₃. The sixth reflected signals 507 may be reflected from the HR coating portion 513.

A seventh reflected signal 508 reflected from the HR coating portion 513 may travel in the direction toward the second AR coating portion 512. In other words, the seventh reflected signals 508 may travel in a direction toward the fourth thin film filter 514-4. At this point, the seventh reflected signal 508 of the fourth wavelength λ₄ may pass through the fourth thin film filter 514-4. That is, the optical DEMUX 510 may output a fourth signal 515-4 of the fourth wavelength λ₄ from the fourth thin film filter 514-4.

When integrated into a ROSA (not shown), the zigzag type optical DEMUX 510 may have a wide optical alignment margin and a low optical insertion loss. However, when the number of wavelengths included in a multiplexed optical signal increases, an optical insertion loss of the zigzag type optical DEMUX 510 may be increased. For example, since the number of reflected instances of an optical signal is increased in the zigzag type optical DEMUX 510 as the number of wavelengths increases, insertion losses of optical channels may be increased.

Further, when the number of wavelengths included in a multiplexed optical signal increases, an optical alignment margin loss of the zigzag type optical DEMUX 510 may be increased. Furthermore, performance of a thin film filter for implementing the zigzag type optical DEMUX 510 may be limited such that application of the zigzag type optical DEMUX 510 to a ROSA using a high-density WDM signal may be restricted. Thus, the zigzag type optical DEMUX 510 may be applied to a high-performance OSA for Ethernet using a medium-density WDM signal.

For convenience of description, FIG. 5 illustrates the optical receiver module 500 including a single optical DEMUX 510. However, the optical receiver module 500 may include a plurality of demultiplexers. Further, for convenience of description, FIG. 5 illustrates the optical DEMUX 510 including a single input channel and four output channels. However, the optical DEMUX 510 may have a plurality of input channels. Further, the optical DEMUX 510 may have less than four output channels or more than four output channels.

Recently, as traffic rapidly increases, a transmission capacity of an optical transceiver needs to be increased. To this end, the number of WDM channels applied to an optical transceiver needs to be increased. The optical DEMUXs 310 to 510 using the AGW method and the thin film filter method, which are described through FIGS. 3 to 5, may be difficult to apply to a high-density WDM signal due to disadvantages of each of the methods.

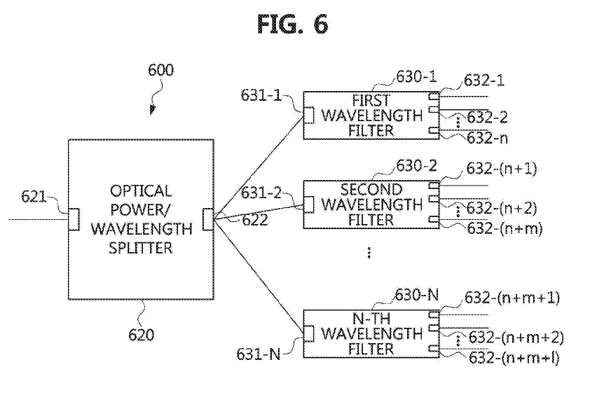

FIG. 6 is a representative structural diagram illustrating an optical DEMUX embedded in an optical receiver module according to an embodiment of the present invention.

Referring to FIG. 6, an optical receiver module 600 may have a structure in which the disadvantages of the optical DEMUXs 310 to 510 using the AGW method and the thin film filter method, which are described through FIGS. 3 to 5, are complemented. For example, the optical receiver module 600 may include an optical DEMUX in which an optical power/wavelength splitter is disposed at a first stage and at least one wavelength filter is disposed at a second stage. The optical receiver module 600 may operate in the same or similar way as the optical receiver module 200 of FIG. 2.

For example, the optical receiver module 600 may include an optical power/wavelength splitter 620 and a plurality of wavelength filters 630-1 to 630-N. The optical power/wavelength splitter 620 and the plurality of wavelength filters 630-1 to 630-N may be a configuration which will be included in the optical DEMUX 310 of FIG. 3.

The optical power/wavelength splitter 620 may be implemented in various ways including a multimode interference (MMI) coupler and a planar waveguide circuit. The optical power/wavelength splitter 620 may have low temperature dependence. Further, the optical power/wavelength splitter 620 may be implemented in a small size. The optical power/wavelength splitter 620 may be divided into an optical power splitter and an optical wavelength splitter. Alternatively, the optical power/wavelength splitter 620 may be implemented in the form in which an optical power splitter and an optical wavelength splitter are combined.

For example, the optical power/wavelength splitter 620 may include an input port 621 and an output port 622. The optical power/wavelength splitter 620 may receive a WDM signal through the input port 621. The optical power/wavelength splitter 620 may split and output the WDM signal into a plurality of channels. For example, the optical power/wavelength splitter 620 may split the WDM signal into a plurality of channels and output the plurality of split channels to the plurality of wavelength filters 630-1 to 630-N through the output port 622.

Each of the plurality of wavelength filters 630-1 to 630-N may include a thin film filter. Each of the plurality of wavelength filters 630-1 to 630-N may include an input port and at least one output port.

For example, the first wavelength filter 630-1 may include a first input port 631-1 and one or more output ports 632-1 to 632-n. The first wavelength filter 630-1 may receive the WDM signal output from the optical power/wavelength splitter 620 through the first input port 631-1. The first wavelength filter 630-1 may split the WDM signal according to wavelengths. The first wavelength filter 630-1 may output split signals through the one or more output ports 623-1 to 632-n.

The second wavelength filter 630-2 may include a second input port 631-2 and one or more output ports 632-(n+1) to 632-(n+m). The second wavelength filter 630-2 may receive the WDM signal output from the optical power/wavelength splitter 620 through the second input port 631-2. The second wavelength filter 630-2 may split the WDM signal according to wavelengths. The second wavelength filter 630-1 may output split signals through the one or more output ports 632-(n+1) to 632-(n+m).

The N-th wavelength filter 630-N may include an N-th input port 631-N and one or more output ports 632-(n+m+1) to 632-(n+m+1). The N-th wavelength filter 630-N may receive the WDM signal output from the optical power/wavelength splitter 620 through the N-th input port 631-N. The N-th wavelength filter 630-N may split the WDM signal according to wavelengths. The N-th wavelength filter 630-1 may output split signals through the one or more output ports 632-(n+m+1) to 632-(n+m+1).

For convenience of description, FIG. 6 illustrates a single output port 622. However, the optical power/wavelength splitter 620 may include two or more output ports. For example, the optical power/wavelength splitter 620 may include N output ports. In this case, an insertion loss of the optical power/wavelength splitter 620 may be a 10×log(1/N) decibel (dB).

According to the number of output ports of the optical power/wavelength splitter 620, the number of input and output channels may be determined for demultiplexing in each of the first to N-th wavelength filters 630-1 to 630-N. Accordingly, the number of input and output channels for demultiplexing in each of the first to N-th wavelength filters 630-1 to 630-N may be reduced. When the number of input and output channels for demultiplexing in each of the first to N-th wavelength filters 630-1 to 630-N is reduced, the optical receiver module 600 may have a wide bandwidth and low adjacent channel crosstalk performance.

For convenience of description, FIG. 6 illustrates the optical receiver module 600 including a single optical power/wavelength splitter 620. However, the optical receiver module 600 may include a plurality of optical power/wavelength splitters. Further, the optical power/wavelength splitter 620 may have a plurality of input and output channels. In other words, the optical power/wavelength splitter 620 may have a plurality of input ports 621 and a plurality of output ports 622.

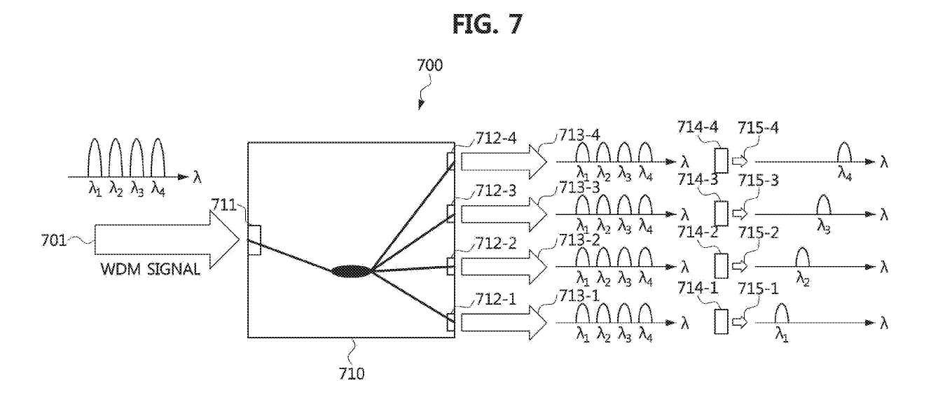

FIG. 7 is a diagram illustrating a 4-channel optical demultiplexer implemented with a 4-channel optical power/wavelength splitter and four wavelength filters according to an embodiment of the present invention.

Referring to FIG. 7, an optical receiver module 700 may operate in the same or similar way as the optical receiver module 600 of FIG. 6.

The optical receiver module 700 may include an optical power/wavelength splitter 710 and a plurality of wavelength filters 714-1 to 714-4. The optical receiver module 700 may include an optical DEMUX. In this case, the optical power/wavelength splitter 710 and the plurality of wavelength filters 714-1 to 714-4 may be included in the optical DEMUX.

The optical power/wavelength splitter 710 may include an input port 711 and a plurality of output ports 712-1 to 712-4. The optical power/wavelength splitter 710 may receive a WDM signal 701 through the input port 711. The WDM signal 701 may be a signal in which first to fourth wavelengths λ₁ to λ₄ are multiplexed. The optical power/wavelength splitter 710 may split the WDM signal into a plurality of channels. For example, the optical power/wavelength splitter 710 may split the WDM signal 701 into the plurality of output ports 712-1 to 712-4.

In other words, the optical power/wavelength splitter 710 may output the WDM signal 701 through the plurality of output ports 712-1 to 712-4. For example, the optical power/wavelength splitter 710 may output a first WDM signal 713-1 to the first wavelength filter 714-1 through the first output port 712-1. The optical power/wavelength splitter 710 may output a second WDM signal 713-2 to the second wavelength filter 714-2 through the second output port 712-2. The optical power/wavelength splitter 710 may output a third WDM signal 713-3 to the third wavelength filter 714-3 through the third output port 712-3. Similarly, the optical power/wavelength splitter 710 may output a fourth WDM signal 713-4 to the fourth wavelength filter 714-4 through the fourth output port 712-4. At this point, each of the first to fourth WDM signals 713-1 to 713-4 may be a signal, similar to the WDM signal 701, in which the first to fourth wavelengths λ₁ to λ₄ are multiplexed.

The first wavelength filter 714-1 may receive the first WDM signal 713-1 through one side of the first wavelength filter 714-1. At this point, the first wavelength filter 714-1 may split the first WDM signal 713-1 according to wavelengths. For example, the first wavelength filter 714-1 may split a first signal 715-1 of the first wavelength λ₁ from the first WDM signal 713-1. That is, the first wavelength filter 714-1 may allow the first signal 715-1 of the first wavelength λ₁ of the first WDM signal 713-1 to pass through the other surface of the first wavelength filter 714-1.

The second wavelength filter 714-2 may receive the second WDM signal 713-2 through one side of the second wavelength filter 714-2. At this point, the second wavelength filter 714-2 may split the second WDM signal 713-2 according to wavelengths. For example, the second wavelength filter 714-2 may split a second signal 715-2 of the first wavelength λ₂ from the second WDM signal 713-2. That is, the second wavelength filter 714-2 may allow the second signal 715-2 of the second wavelength λ₂ of the second WDM signal 713-2 to pass through the other surface of the second wavelength filter 714-2.

The third wavelength filter 714-3 may receive the third WDM signal 713-3 through one side of the third wavelength filter 714-3. At this point, the third wavelength filter 714-3 may split the third WDM signal 713-3 according to wavelengths. For example, the third wavelength filter 714-3 may split a third signal 715-3 of the third wavelength λ₃ from the third WDM signal 713-3. That is, the third wavelength filter 714-3 may allow the third signal 715-3 of the third wavelength λ₃ of the third WDM signal 713-3 to pass through the other surface of the third wavelength filter 714-3.

Similarly, the fourth wavelength filter 714-4 may receive the fourth WDM signal 713-4 through one side of the fourth wavelength filter 714-4. At this point, the fourth wavelength filter 714-4 may split the fourth WDM signal 713-4 according to wavelengths. For example, the fourth wavelength filter 714-4 may split a fourth signal 715-4 of the fourth wavelength λ₄ from the fourth WDM signal 713-4. That is, the fourth wavelength filter 714-4 may allow the fourth signal 715-4 of the fourth wavelength λ₄ of the fourth WDM signal 713-4 to pass through the other surface of the fourth wavelength filter 714-3.

The optical power/wavelength splitter 710 may be disposed at a first stage of the optical receiver module 700. An insertion loss of the optical power/wavelength splitter 710 having four output ports may be 10×log (4)=6 dB. The plurality of wavelength filters 714-1 to 714-4 may be disposed at a second stage of the optical receiver module 700. In this case, each of the plurality of wavelength filters 714-1 to 714-4 may split only a signal of a predetermined wavelength. Accordingly, the optical receiver module 700 does not require a zigzag configuration such as that of the optical DEMUX 510 of FIG. 5.

Thus, the optical receiver module 700 may have wide bandwidth performance and low adjacent channel crosstalk performance. Further, when a flat optical waveguide is applied to the optical receiver module 700, various methods such as fiber bragg grating (FBG) and the like may be applied. Furthermore, since a channel for demultiplexing is a single channel, the design for the optical receiver module 700 may be convenient. Therefore, the optical receiver module 700 implemented in multiple stages may have high performance and high efficiency and high mass productivity.

For convenience of description, FIG. 7 illustrates the optical receiver module 700 including a single optical power/wavelength splitter 710 and the four wavelength filters 714-1 to 714-4. However, the optical receiver module 700 may include a plurality of optical power/wavelength splitters. Further, the optical receiver module 700 may include less than or more than four wavelength filters.

For convenience of description, FIG. 7 illustrates the optical power/wavelength splitter 710 including a single input channel and four output channels. However, the optical power/wavelength splitter 710 may have a plurality of input channels. Further, the optical power/wavelength splitter 710 may have less than or more than four output channels. That is, the optical power/wavelength splitter 710 may have a plurality of input ports 711. Further, the optical power/wavelength splitter 710 may have less than or more than four output ports.

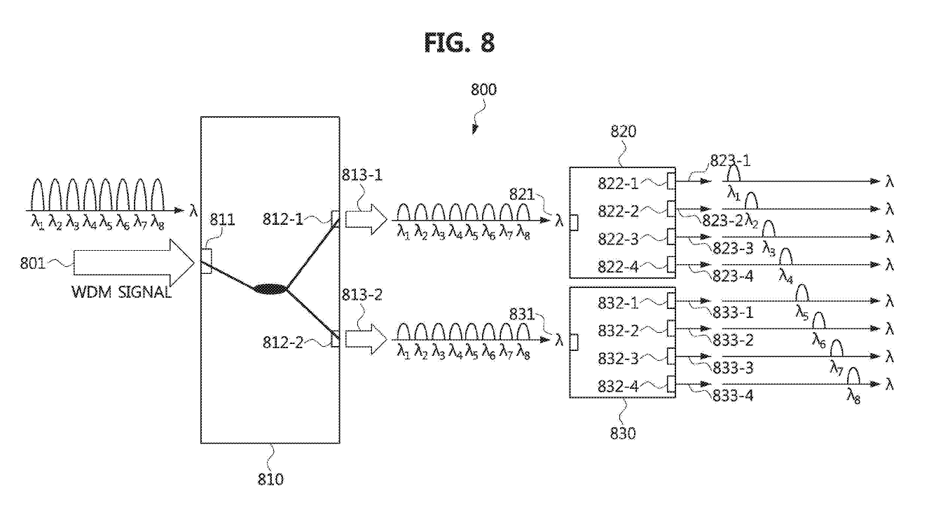

FIG. 8 is a diagram illustrating an 8-channel optical demultiplexer implemented with a 2-channel optical power/wavelength splitter and two wavelength filters according to an embodiment of the present invention.

Referring to FIG. 8, an optical receiver module 800 may operate in the same or similar way as the receiving device 600 of FIG. 6.

The optical receiver module 800 may include an optical power/wavelength splitter 810, a first wavelength filter 820, and a second wavelength filter 830. The optical receiver module 800 may include an optical DEMUX. In this case, the optical power/wavelength splitter 810, the first wavelength filter 820, and the second wavelength filter 830 may be included in the optical DEMUX.

The optical power/wavelength splitter 810 may include an input port 811, a first output port 812-1, and a second output port 812-2. The optical power/wavelength splitter 810 may receive a WDM signal 801 through the input port 811. The WDM signal 801 may be a signal in which first to eighth wavelengths λ₁ to λ₈ are multiplexed. The optical power/wavelength splitter 810 may split a WDM signal 801 into a plurality of channels. For example, the optical power/wavelength splitter 810 may split the WDM signal 801 to a first output port 812-1 and a second output port 812-2.

In other words, the optical power/wavelength splitter 810 may output the WDM signal 801 through the first and second output ports 812-1 and 812-2. For example, the optical power/wavelength splitter 810 may output a first WDM signal 813-1 to the first wavelength filter 820 through the first output port 812-1. Further, the optical power/wavelength splitter 810 may output a second WDM signal 813-2 to the second wavelength filter 830 through the second output port 812-2. At this point, each of the first WDM signal 813-1 and the second WDM signal 813-2 is a signal, similar to the WDM signal 801, in which the eight wavelengths λ₁ to λ₈ are multiplexed.

The first wavelength filter 820 may include an input port 821 and first to fourth output ports 822-1 to 822-4. The first wavelength filter 820 may receive the first WDM signal 813-1 through the first input 821. At this point, the first wavelength filter 820 may split the first WDM signal 813-1 according to wavelengths.

For example, the first wavelength filter 820 may split a first signal 823-1 of the first wavelength λ₁ from the first WDM signal 813-1. That is, the first wavelength filter 820 may output the first signal 823-1 of the first wavelength λ₁ of the first WDM signal 813-1 through the first output part 822-1. Further, the second wavelength filter −2 may split a second signal 823-2 of the second wavelength λ₂ from the first WDM signal 813-1. The first wavelength filter 820 may allow the second signal 823-2 of the second wavelength λ₂ of the first WDM signal 813-1 to pass through the second output port 822-2. Further, the first wavelength filter 820 may split a third signal 823-1 of the third wavelength λ₃ from the first WDM signal 813-1. The first wavelength filter 820 may output the third signal 823-1 of the third wavelength λ₃ of the first WDM signal 813-1 through the third output part 822-3. Similarly, the first wavelength filter 820 may split a fourth signal 823-4 of the fourth wavelength λ₄ from the first WDM signal 813-1. The first wavelength filter 820 may output the second signal 823-4 of the second wavelength λ₄ of the first WDM signal 813-1 through the second output port 822-4.

The second wavelength filter 830 may include an input port 831 and first to fourth output ports 832-1 to 832-4. The second wavelength filter 830 may receive the second WDM signal 813-2 through the second input port 831. At this point, the second wavelength filter 830 may split the second WDM signal 813-2 according to wavelengths.

The second wavelength filter 830 may split a fifth signal 833-1 of the fifth wavelength λ₅ from the second WDM signal 813-2. The second wavelength filter 830 may output the fifth signal 833-1 of the fifth wavelength λ₈ of the second WDM signal 813-2 through a fifth output port 832-1. The second wavelength filter 830 may split a sixth signal 833-2 of the sixth wavelength λ₆ from the second WDM signal 813-2. The second wavelength filter 830 may output the sixth signal 833-2 of the sixth wavelength λ₆ of the second WDM signal 813-2 through a sixth output port 832-2. The second wavelength filter 830 may split a seventh signal 833-3 of the seventh wavelength λ₇ from the second WDM signal 813-2. The second wavelength filter 830 may output the seventh signal 833-3 of the seventh wavelength λ₄ of the second WDM signal 813-2 through a seventh fifth output port 832-3. Similarly, the second wavelength filter 830 may split an eighth signal 833-4 of the eighth wavelength λ₈ from the second WDM signal 813-2. The second wavelength filter 830 may output the eighth signal 833-4 of the eighth wavelength λ₈ of the second WDM signal 813-2 through an eighth output port 832-4.

The optical power/wavelength splitter 810 may be disposed at a first stage of the optical receiver module 800. An insertion loss of the optical power/wavelength splitter 810 having two output ports may be 10×log (2)=3 dB. The plurality of wavelength filters 820 and 830 may be disposed at a second stage of the optical receiver module 800. At this point, each of the plurality of wavelength filters 820 and 830 may split signals of four predetermined wavelengths. Since each of the plurality of wavelength filters 820 and 830 may split signals of four wavelengths through four channels, the optical receiver module 800 may have a wide optical alignment margin and a wide bandwidth. Further, when a PLC is applied to the optical receiver module 800, the PLC may be designed to have wider bandwidth performance and lower adjacent channel crosstalk performance than a receiver structure including a single wavelength filter having eight demultiplexing channels. Accordingly, the optical receiver module 800 may have high performance and high efficiency and have high mass productivity.

For convenience of description, FIG. 8 illustrates the optical receiver module 800 including a single optical power/wavelength splitter 810 and the two wavelength filters 820 and 830. However, the optical receiver module 800 may include a plurality of optical power/wavelength splitters. Further, the optical receiver module 800 may include a single wavelength filer or more than two wavelength filters.

For convenience of description, FIG. 8 illustrates the optical power/wavelength splitter 810 including a single input channel and two output channels. However, the optical power/wavelength splitter 810 may have a plurality of input channels. Further, the optical power/wavelength splitter 810 may have a single output channel or more than two output channels. However, the optical power/wavelength splitter 810 may have a plurality of input ports. Further, the optical power/wavelength splitter 810 may have a single output port or more than two output ports.

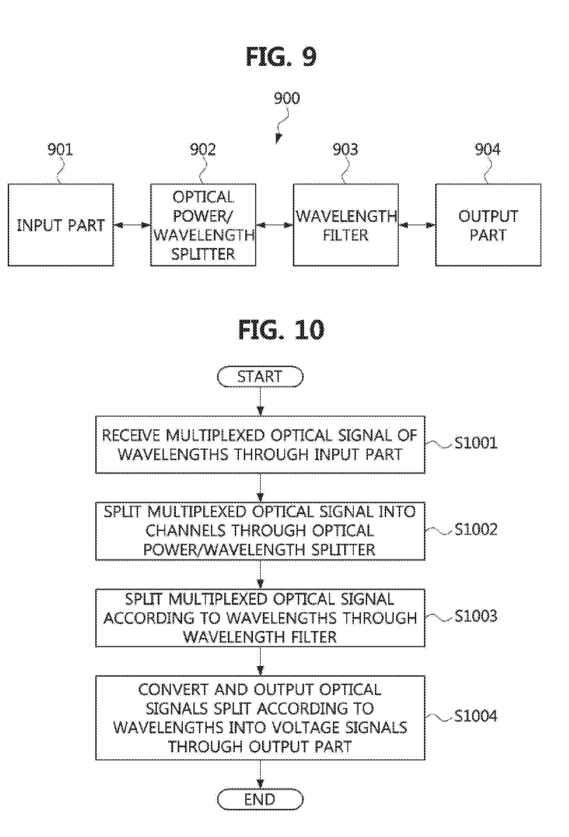

FIG. 9 is a representative block diagram illustrating an optical receiver module according to an embodiment of the present invention.

Referring to FIG. 9, an optical receiver module 900 may operate in the same or similar way as the optical receiver module 600 of FIG. 6.

The optical receiver module 900 may include an input part 901, an optical power/wavelength splitter 902, a wavelength filter 903, and a plurality of output parts 904. The optical receiver module 900 may operate in the same or similar way as the optical receiver modules 600 to 800 of FIGS. 6 to 8.

The input part 901 may receive a multiplexed optical signal of a plurality of wavelengths. The optical power/wavelength splitter 902 may split the multiplexed optical signal into a plurality of channels. The wavelength filter 903 may split the split multiplexed optical signal according to the plurality of wavelengths. The plurality of output parts 904 may convert the optical signals split according to the plurality of wavelengths into voltage signals and output the voltage signals.

The optical power/wavelength splitter 902 may include an input port and a plurality of output ports. An optical power/wavelength splitter 902 may receive the multiplexed optical signal through the input port. The optical power/wavelength splitter 902 may output the split multiplexed optical signal to the wavelength filter 903 through each of the plurality of output ports 904.

The wavelength filter 903 may include a plurality of wavelength filters. Each of the plurality of wavelength filters may receive the multiplexed optical signal output from the optical power/wavelength splitter 902. Each of the plurality of wavelength filters may split the multiplexed optical signal into at least one optical signal of a predetermined wavelength.

The wavelength filter 903 may include first to fourth wavelength filters. The first wavelength filter may split a first optical signal of the first wavelength from the multiplexed optical signal. The second wavelength filter may split a second optical signal of the second wavelength from the multiplexed optical signal. The third wavelength filter may split a third optical signal of the third wavelength from the multiplexed optical signal. The fourth wavelength filter may split a fourth optical signal of the fourth wavelength from the multiplexed optical signal.

The wavelength filter 903 may include a first wavelength filter and a second wavelength filter. The first wavelength filter may split a first optical signal of a first wavelength from the multiplexed optical signal, a second optical signal of a second wavelength therefrom, a third optical signal of a third wavelength therefrom, and a fourth optical signal of a fourth wavelength therefrom.

The second wavelength filter may split a fifth optical signal of a fifth wavelength from the multiplexed optical signal, a sixth optical signal of a sixth wavelength therefrom, a seventh optical signal of a seventh wavelength therefrom, and an eighth optical signal of an eighth wavelength therefrom.

The optical power/wavelength splitter 902 may include an interferometric coupler or a planar waveguide circuit. The wavelength filter 903 may include at least one thin film filter.

The optical receiver module 900 may further include an optical DEMUX for demultiplexing the multiplexed optical signal. The optical DEMUX may include the optical power/wavelength splitter 902 and the wavelength filter 903.

The optical power/wavelength splitter 902 may be disposed at a first stage of the optical DEMUX. The wavelength filter 903 may be disposed at a second end of the optical DEMUX.

Each of the plurality of output parts 904 may include an optical detector and an amplifier. The optical detector may detect optical signals split according to the plurality of wavelengths. The optical detector may convert the detected optical signals into current signals and output the current signals. The amplifier may convert the converted current signals into voltage signals and output the voltage signals.

The optical detector may include a plurality of PDs. The amplifier may include a linear TIA having a plurality of input and output channels.

FIG. 10 is a flowchart illustrating an operation method of the optical receiver module according to the embodiment of the present invention.

Referring to FIG. 10, an optical receiver module may operate in the same or similar way as the optical receiver modules 600 to 900 of FIGS. 6 to 9.

An operation method of the optical receiver module may include receiving a multiplexed optical signal of a plurality of wavelengths through an input part (S1001).

The operation method of the optical receiver module may include splitting the multiplexed optical signal into a plurality of channels through an optical power/wavelength splitter (S1002).

The operation method of the optical receiver module may include splitting the split multiplexed optical signal according to the plurality of wavelengths through a wavelength filter (S1003).

The operation method of the optical receiver module may include converting the optical signals split according to the plurality of wavelengths into current signals and outputting the converted current signals through a plurality of output parts (S1004).

The splitting of the multiplexed optical signal into the plurality of channels through then optical power/wavelength splitter may include receiving the multiplexed optical signal through an input port of the optical power/wavelength splitter and outputting the split optical signals to the wavelength filter through each of the plurality of output ports of the optical power/wavelength splitter.

The splitting of the split multiplexed optical signal according to the plurality of wavelengths through the wavelength filter may include receiving the multiplexed optical signal output from the optical power/wavelength splitter through each of a plurality of wavelength filters included in the wavelength filter.

The splitting of the split multiplexed optical signal according to the plurality of wavelengths through the wavelength filter may further include splitting at least one optical signal of predetermined wavelengths through each of the plurality of wavelength filters.

The splitting of the split multiplexed optical signal according to the plurality of wavelengths through the wavelength filter may include splitting a first optical signal of a first wavelength of the multiplexed optical signal through a first wavelength filter among the plurality of wavelength filters, splitting a second optical signal of a second wavelength of the multiplexed optical signal through a second wavelength filter among the plurality of wavelength filters, splitting a third optical signal of a third wavelength of the multiplexed optical signal through a third wavelength filter among the plurality of wavelength filters, and splitting a fourth optical signal of a fourth wavelength of the multiplexed optical signal through a fourth wavelength filter among the plurality of wavelength filters.

The splitting of the split multiplexed optical signal according to the plurality of wavelengths through the wavelength filter may include splitting the first optical signal of the first wavelength of the multiplexed optical signal, the second optical signal of the second wavelength thereof, the third optical signal of the third wavelength thereof, and the fourth optical signal of the fourth wavelength through the first wavelength filter among the plurality of wavelength filters, and splitting a fifth optical signal of a fifth wavelength of the multiplexed optical signal, a sixth optical signal of a sixth wavelength thereof, a seventh optical signal of a seventh wavelength thereof, and an eighth optical signal of an eight wavelength through the first wavelength filter among the plurality of wavelength filters.

The converting of the optical signals split according to the plurality of wavelengths into the current signals and the outputting of the converted current signals may include detecting the optical signals split according to the plurality of wavelengths and converting and outputting the detected optical signals into current signals.

The converting of the optical signals split according to the plurality of wavelengths into the current signals and the outputting of the converted current signals may further include converting and outputting the converted current signals into the voltage signals.

The method according to the present invention may be implemented in the form of a program command which is executable through various computer devices and be recorded in a computer-readable medium. The computer-readable medium may include program instructions, data files, data structures, and the like alone or by combination thereof. The program instructions recorded in the computer-readable medium may be specially designed and configured for the present invention or may be available to those skilled in the computer software.

Examples of the computer-readable medium include specially configured hardware, such as a ROM, a RAM, a flash memory, and the like, for storing and performing program instructions. Examples of the program instructions include machine language codes generated by a compiler, as well as high-level language codes which are executable by a computer using an interpreter or the like. The above-described hardware may be configured to operate as at least one software module so as to perform an operation of the present invention, and vice versa.

In accordance with the present invention, an optical power/wavelength splitter is disposed at a first stage and a plurality of wavelength filters are disposed at a second stage such that there is an effect in that the number of channels for demultiplexing a multiplexed optical signal can be reduced, and wide bandwidth performance and low adjacent channel crosstalk performance can be attained with respect to a multiplexed optical signal. Further, an optical receiver module can be integrated into a single module by disposing the optical power/wavelength splitter at the first stage and the plurality of wavelength filters at the second stage such that there is an effect in that a design can be simplified and a manufacturing process can be simplified, thereby reducing manufacturing costs.

Although the description has been made with reference to the embodiments of the present invention, it should be understood that various alternations and modifications of the present invention can be devised by those skilled in the art to which the present invention pertains without departing from the spirit and scope of the present invention, which are defined by the appended claims.

What is claimed is:

1. An optical receiver module comprising:
an input part configured to receive a multiplexed optical signal of a plurality of wavelengths;
an optical power/wavelength splitter configured to split the multiplexed optical signal into a plurality of channels;
a wavelength filter configured to split the split multiplexed optical signal according to the plurality of wavelengths; and
an output part configured to convert optical signals split according to the plurality of wavelengths into voltage signals and output the converted voltage signals.

2. The optical receiver module of claim 1, wherein:
the optical power/wavelength splitter includes an input port and a plurality of output ports; and
the optical power/wavelength splitter receives the multiplexed optical signal through the input port and outputs the split multiplexed optical signal to the wavelength filter through each of the plurality of output ports.

3. The optical receiver module of claim 1, wherein:
the wavelength filter includes a plurality of wavelength filters; and
each of the plurality of wavelength filters receives the multiplexed optical signal output from the optical power/wavelength splitter.

4. The optical receiver module of claim 3, wherein each of the plurality of wavelength filters splits at least one optical signal of a predetermined wavelength.

5. The optical receiver module of claim 3, wherein:
the wavelength filter includes a first wavelength filter, a second wavelength filter, a third wavelength filter, and a fourth wavelength filter;
the first wavelength filter splits a first optical signal of a first wavelength from the multiplexed optical signal;
the second wavelength filter splits a second optical signal of a second wavelength from the multiplexed optical signal;
the third wavelength filter splits a third optical signal of a third wavelength from the multiplexed optical signal; and
the fourth wavelength filter splits a fourth optical signal of a fourth wavelength from the multiplexed optical signal.

6. The optical receiver module of claim 3, wherein:
the wavelength filter includes a first wavelength filter and a second wavelength filter;
the first wavelength filter splits a first optical signal of a first wavelength from the multiplexed optical signal, a second optical signal of a second wavelength therefrom, a third optical signal of a third wavelength therefrom, and a fourth optical signal of a fourth wavelength therefrom; and
the second wavelength filter splits a fifth optical signal of a fifth wavelength therefrom, a sixth optical signal of a sixth wavelength therefrom, a seventh optical signal of a seventh wavelength therefrom, and an eighth optical of an eighth wavelength therefrom.

7. The optical receiver module of claim 1, wherein the optical power/wavelength splitter includes a multimode interference (MMI) coupler.

8. The optical receiver module of claim 1, wherein the optical power/wavelength splitter includes a planar waveguide circuit (PWC).

9. The optical receiver module of claim 1, wherein the wavelength filter includes at least one thin film filter (TFF).

10. The optical receiver module of claim 1, further comprising an optical demultiplexer configured to demultiplex the multiplexed optical signal.

11. The optical receiver module of claim 10, wherein the optical demultiplexer includes the optical power/wavelength splitter and the wavelength filter.

12. The optical receiver module of claim 11, wherein:
the optical power/wavelength splitter is disposed at a first stage of the optical demultiplexer; and
the wavelength filter is disposed at a second stage of the optical demultiplexer.

13. The optical receiver module of claim 1, wherein the output part includes an optical detector and an amplifier.

14. The optical receiver module of claim 13, wherein:
the optical detector detects the optical signals split according to the plurality of wavelengths, converts the detected optical signals into current signals, and outputs the converted current signals; and
the amplifier converts the converted current signals into the voltage signals and outputs the converted voltage signals.

15. The optical receiver modules of claim 14, wherein the optical detector includes a plurality of photodiodes.
